(19) United States
(12) Patent Application Publication
(10) Pub. No.: US 2007/0085815 A1
(43) Pub. Date: Apr. 19, 2007

(54) Automatic liquid crystal display contrast adjustment

(75) Inventors: Christopher L. Oesterling, Troy, MI (US); Mingheng Wang, Rochester Hills, MI (US); Matthew G. Przybyleski, Grand Blanc, MI (US)

Correspondence Address: GENERAL MOTORS CORPORATION;LEGAL STAFF, MAIL CODE 482-C23-B21, P O BOX 300, DETROIT, MI, 48265-3000, US

(73) Assignee: General Motors Corporation

(21) Appl. No.: 11/251,379

(22) Filed: Oct. 14, 2005

(51) Int. Cl. G09G 3/36

(52) U.S. Cl. 345/102

(57) ABSTRACT

A display, a method of controlling contrast of a liquid crystal display, and a liquid crystal display. The display includes a liquid crystal panel and a controller for controlling contrast voltage to the liquid crystal panel. The display further includes a temperature sensor operably attached to the controller. A display contrast of the liquid crystal panel is based on the contrast voltage. The contrast voltage is based on a sensed temperature of the temperature sensor. The method includes sensing a temperature. A contrast voltage to the liquid crystal display is controlled based on the sensed temperature. The liquid crystal display includes means for sensing a temperature; and means for controlling contrast voltage to the liquid crystal display based on the sensed temperature.

### FIELD OF THE INVENTION

This invention relates generally to liquid crystal displays. More specifically, the invention relates to a strategy for automatically adjusting contrast of a liquid crystal display.

### BACKGROUND OF THE INVENTION

An ever increasing number of digital devices utilize a liquid crystal display (LCD). An LCD provides numerous advantages over other display technologies, such a cathode ray tube (CRT). For example, an LCD consumes relatively less power, is smaller in size (e.g., thinner), and lighter compared to a CRT.

LCD technology is based on the principle that liquid crystal material, when in a solid state, maintains a certain molecular orientation. When in a liquid state, the material can change orientation and move freely about. The state of the liquid crystal material is controlled by an applied electric voltage (e.g., a contrast voltage). For example, twisted nematic (TN) liquid crystals are naturally twisted. Application of an electric voltage to the crystals results in a predictable untwisting in proportion to the applied voltage. This principle may be used to control light passage through the crystals and, thus, display visual information on the LCD. Specifically, light passes through the twisted crystals to a greater degree than the untwisted crystals.

FIG. 1 is a cross-sectional view of a prior art simple twisted nematic (TN) liquid crystal display 100. In this example, the TN display 100 includes two polarizers 130, 170, two pieces of transparent material (e.g., glass or plastic) 140, 160, and a liquid crystal portion 150. Liquid crystal portion 150 includes TN crystals, a switching element or common electrode plane to define pixels, and driver integrated circuits to address the rows and columns of pixels. To define a pixel (or sub-pixel element for a color display), a contrast voltage is applied to the common electrode plane, which is typically constructed from indium tin oxide or other like material, to change the orientation of the TN crystals (i.e., from a twisted, or light pixel, to an untwisted, or dark pixel). The orientation of the TN crystals is proportional to the contrast voltage applied to the common electrode plane. The TN crystals have a defined range from which they can be fully twisted to fully untwisted. The range constitutes the contrast ratio of the liquid crystal portion 150 (i.e., the ratio of the maximum white to the minimum black of the liquid crystal portion 150; a larger ratio equates to a higher maximum contrast).

Polarizers 130, 170, allow light 120 produced by a backlight 110 to pass if it is oriented in a specific (oriented) direction. Specifically, the polarizer 130 orients incoming light 120 in one uniform direction. The oriented light 120 passes through the TN crystals and is either unaltered or “bent” about 90 degrees. Depending on the orientation of the polarizer 170, the light 120 will pass through and be visible on the surface 180 of the polarizer 170 as a light area or be diffused. If the light 120 is diffused, it will appear as a darkened area. The structure and operation of liquid crystal displays is known to those skilled in the art. It will be appreciated that the display 100 may vary from the description and illustrations provided herein without departing from the spirit and scope of the present invention. For example, various displays include different types of liquid crystal as well as backlights positioned above and/or beside the liquid crystal portion.

Display contrast of LCDs is sensitive to temperature outside of a certain operational range. The display contrast relates to the difference in visual properties that makes a given displayed object distinguishable from other objects and/or the background. For example, in colder temperatures, the liquid crystal material may solidify (e.g., untwist) resulting in a “darkened” display, thereby making a display object hard to distinguish from another object and/or background. Conversely, in higher temperatures, the liquid crystal material may liquefy (e.g., twist) resulting in a “lightened” display, thereby also making a display object hard to distinguish from another object and/or background. In either instance, temperature extremes can affect the LCD contrast and hamper its visual performance.

It is an object of this invention, therefore, to provide a strategy for automatically adjusting the contrast of a liquid crystal display, and to overcome the deficiencies and obstacles described above.

### SUMMARY OF THE INVENTION

One aspect of the invention provides a display. The display includes a liquid crystal panel and a controller for controlling contrast voltage to the liquid crystal panel. The display further includes a temperature sensor operably attached to the controller. A display contrast of the liquid crystal panel is based on the contrast voltage. The contrast voltage is based on a sensed temperature of the temperature sensor.

Another aspect of the invention provides a method of controlling contrast of a liquid crystal display. The method includes sensing a temperature. A contrast voltage to the liquid crystal display is controlled based on the sensed temperature.

Another aspect of the invention provides a liquid crystal display. The liquid crystal display includes means for sensing a temperature and means for controlling contrast voltage to the liquid crystal display based on the sensed temperature.

The aforementioned, and other features and advantages of the invention will become further apparent from the following detailed description of the presently preferred examples, read in conjunction with the accompanying drawings. The detailed description and drawings are merely illustrative of the invention rather than limiting, the scope of the invention being defined by the appended claims and equivalents thereof.

### BRIEF DESCRIPTION OF THE DRAWINGS

FIG. 1 is a prior art cross-sectional view of a simple twisted nematic (TN) liquid crystal display

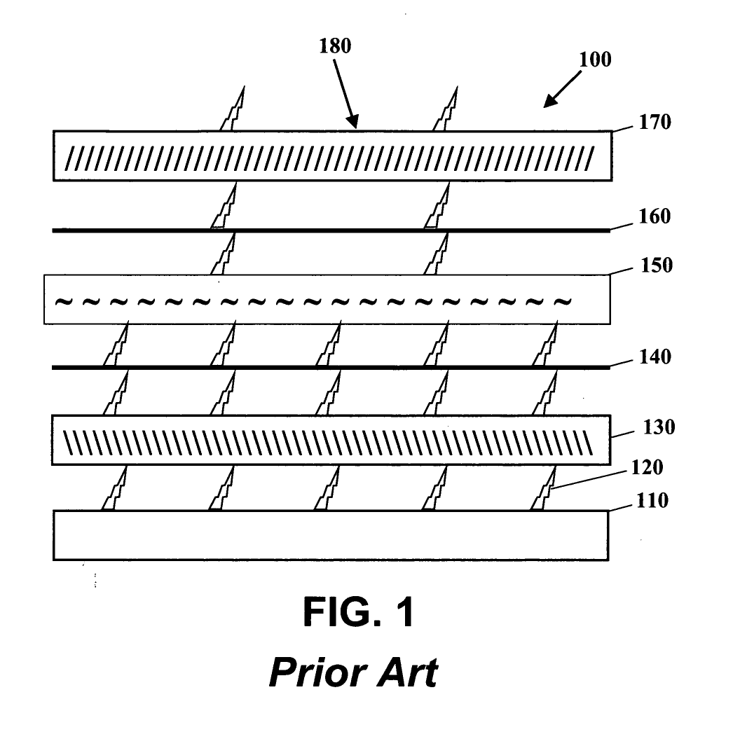

FIG. 2A illustrates a display operably attached to a telematics unit in a vehicle, in accordance with one example of the present invention;

FIG. 2B is a schematic view of the display and telematics unit shown in FIG. 2A; and

FIG. 3 illustrates a flowchart of a method for controlling contrast of a liquid crystal display, in accordance with one example of the present invention.

### DETAILED DESCRIPTION OF THE PRESENTLY PREFERRED EXEMPLARY EMBODIMENTS

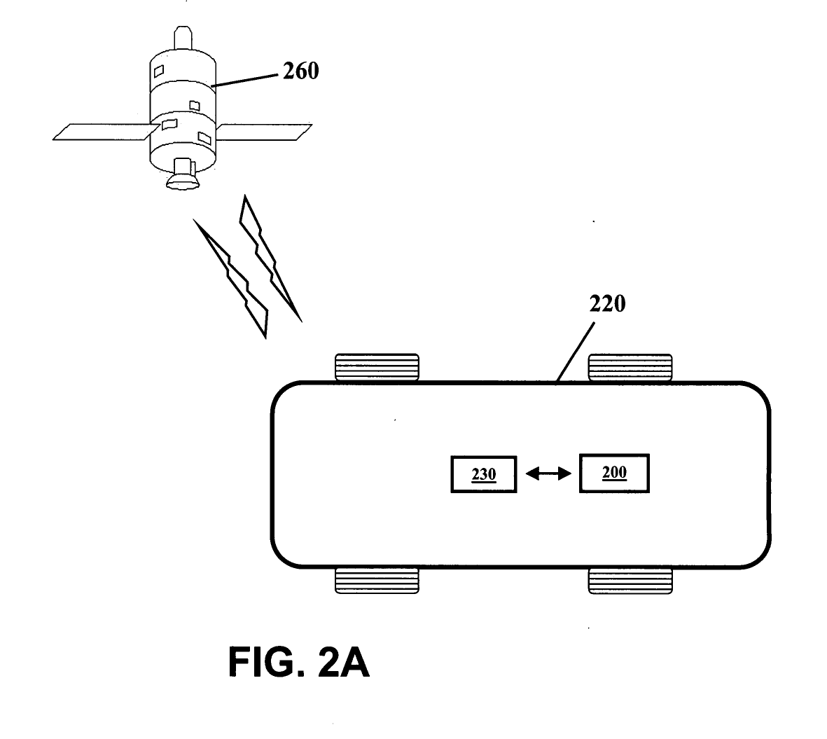

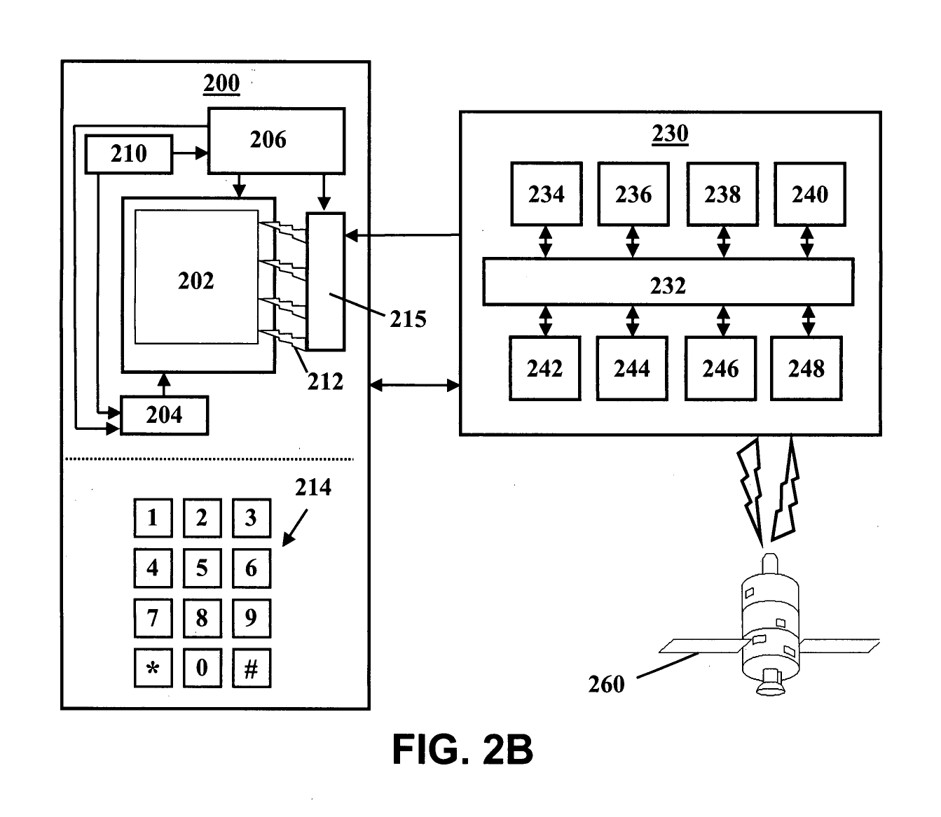

FIG. 2A illustrates a display 200, in accordance with one example of the present invention. In one example, display 200 is a liquid crystal-type display. In one example, display 200 is implemented in a vehicle 220. In one example, display 200 is implemented as part of a system for navigation using a satellite-radio broadcast system and is operably attached to a telematics unit 230. Telematics unit 230 is in communication with one or more satellite broadcast systems 260. Vehicle 220 may be a motor vehicle, a marine vehicle, an aircraft, and the like. In other examples, the display 200 is implemented as part of a portable or home computer, flatscreen television, clock, cellular telephone, personal digital assistant (PDA), watch, dialing keypad, and the like. Those skilled in the art will recognize that the display 200 can be implemented in a variety of electronic devices and is not limited to the applications described and illustrated herein.

FIG. 2B is a schematic view of the display and telematics unit shown in FIG. 2. Display 200 includes a liquid crystal panel 202 and a controller 204, in this example a microcontroller, for controlling contrast voltage to the liquid crystal panel 202. A power supply 206 provides power voltage and contrast voltage to the liquid crystal panel 202, a backlight 215, and a temperature control unit 210. Backlight 215 provides a source of light 212 to the liquid crystal panel 202. Temperature control unit 210 regulates temperature (i.e., by providing heat and/or cooling) of the liquid crystal panel 202. Display 200, in one example, is a wireless dialing keypad. Display 200 includes a plurality of numeric input buttons 214. In one example, display 200 provides Telecommunications Device for the Deaf (TDD; a.k.a. TTY) functionality. Numeric input buttons 214 include alphabetic buttons for text entry, in one example. In another example, (alpha) numeric buttons are integrated directly into the liquid crystal panel 202 and operated by a numerous means (e.g., a stylus, finger touch, etc.) for devices such as personal digital assistants (PDAs), touch-screen devices, and the like. Liquid crystal panel 202 can be one of any numerous liquid crystal panels known in the art. For example, the liquid crystal panel can be a passive matrix, active matrix, or color panel display.

Display 200 is operably attached to the telematics unit 230. Many passenger vehicles now incorporate an integrated communication system. Such telematics units provide a variety of fee-based subscription services in a mobile environment including navigational assistance. Telematics unit 230 is configured to establish or receive a radio communication link between the telematics unit 230 and a call center through a Wide Area Network (WAN), using a node of a WAN that can send and receive signals to and from telematics unit 230. Telematics unit 230 is a wireless communications system designed for the collection and dissemination of information, vehicle tracking and positioning, on-line vehicle navigation and information systems and emergency assistance.

In one example, the telematics unit 230 includes a processor 232 connected to a wireless modem 234, an in-vehicle memory 236, a microphone 138, one or more speakers 240, a real time clock providing current time and date 242, an ambient light sensor 244, a global positioning system (GPS) unit 246, and a temperature sensor 248. In other examples, telematics unit 230 is implemented without one or more of the above listed components such as, for example, speakers 240. Telematics unit 230 may include additional components not relevant to the present discussion.

Display 200 and telematics unit 230 are implemented within a motor vehicle, a marine vehicle, or as an aircraft, in various examples. Telematics units are known to those skilled in the art. In certain examples, one or more components of the telematics unit 230 are integrated within the display 200 thereby, potentially, providing a device, such as a PDA or cellular telephone, with many or all of the features described herein. In one example, the display 200 is a TN-type display. In another example, the display 200 is another type or design of liquid crystal display.

In one example, processor 232 is implemented as a microcontroller, controller, host processor, or a vehicle communications processor. Processor 232 includes digital signal processing capabilities. Time and date sensor 242 provides time and date information. Ambient light sensor 244 detects lighting conditions (e.g., day or night) in one or more locations (e.g., adjacent the display 200 as well as inside and/or outside the vehicle 220). GPS unit 246 provides latitudinal and longitudinal coordinates of the vehicle responsive to a GPS broadcast signal received from a GPS satellite broadcast system (not shown). Telematics unit 230 sends and receives radio signals from the satellite broadcast system 260. In another example, the satellite broadcast systems 260, or other broadcast system(s), transmits the time, date, light, and vehicle latitudinal and longitudinal coordinates to the telematics unit 230 and/or the display 200. Temperature sensor 248 provides ambient temperature readings, preferably within the cabin of the vehicle 220, and more preferably, adjacent to the display 200.

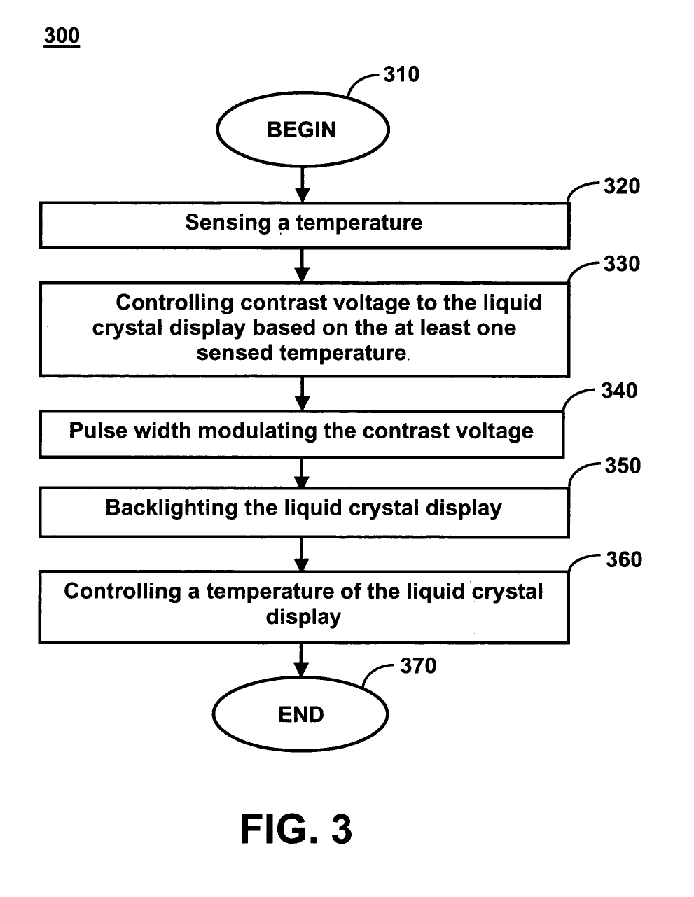

FIG. 3 illustrates a flowchart of a method 300 representative of one example of a method of controlling contrast of a liquid crystal display 200. Method 300 begins at 310.

At step 320, in one example, the temperature is sensed. In one example, the temperature is sensed with a temperature sensor 248 in communication with the telematics unit 230. In another example, the temperature is sensed with a temperature sensor integrated with the display 200. In one example, the sensed temperature is received at the controller.

At step 330, contrast voltage to the liquid crystal display 200, specifically, the liquid crystal panel 202 is adjusted based on the sensed temperature. In one example, the contrast voltage is based on an inversely proportional relationship between it and the sensed temperature (i.e., by adjusting the contrast voltage accordingly). For example, at relatively colder temperatures, the contrast voltage is increased over a nominal level. The increases become greater as the temperature decreases. As such, increasing the contrast voltage in relatively colder temperatures will increase the contrast ratio, thereby allowing a user to better visualize information on the liquid crystal panel 202, which would normally appear dark or “blacked-out”. Conversely, decreasing the contrast voltage in relatively warmer temperatures will increase the contrast ratio, thereby allowing a user to better visualize information on the liquid crystal panel 202, which would normally appear light or “washed-out”. In one example, the contrast voltage and the degree of its increase or decrease is determined for a given unit design experimentally by, for example, measuring contrast ratios at various temperatures. This calibration process, when implemented during a design phase, can be performed by one skilled in the art and vary by the type of the display. Various liquid crystal panel types have different operating ranges and sensitivities to temperature extremes. Such factors should be considered during the calibration process. In other examples, the degree of contrast is adjusted with user controls, such as a knob, to further control the contrast within a range of contrasts set off from a baseline contrast determined in response to a sensed temperature. After adjusting the contrast voltage to be applied to liquid crystal panel 202, the contrast voltage is applied to liquid crystal panel 202.

At step 340, the contrast voltage is pulse width modulated. Pulse width modulation (PWM) is a technique for controlling analog circuits with a microprocessor's digital outputs, where variable length pulses represent the amplitude of an analog signal. In one example, PWM is performed by the controller 204. In another example, PWM is performed by the processor 232. PWM is employed in a wide variety of applications, ranging from measurements and communications to power control and conversion. PWM generally is a constant stream of pulses of a fixed frequency, fixed amplitude, and variable duration. The duty cycle of the pulse can fall within a 0% to a 100% duty cycle. In this case, PWM converts the contrast voltage, which comes from an analog power supply and may vary over time, into a more constant contrast voltage. As a result, the contrast of the liquid crystal panel 202 would be better maintained thereby producing a higher-quality picture. PWM is understood by those skilled in the art.

At step 350, the liquid crystal panel 202 is backlit. In one example, the backlight 215 provides light 212. Those skilled in that art will appreciate that the backlight 215 need not be positioned behind the liquid crystal panel 150; but may instead or additionally be positioned above and/or beside liquid crystal panel 150. To correct the contrast and visual appearance of the image on the liquid crystal panel 202, the intensity of the light 212 from the backlight 215 can be adjusted. For example, in darker environments, it is desirable to increase the light 212 intensity. As the backlight 215 consumes a large proportion of the overall power consumed by the display 100, light 212 intensity adjustment can save overall power usage as an additional benefit. In one example, the light 212 intensity is adjusted by sensing time (e.g., by an internal clock, telecommunicated time, and the like), date (e.g. by an internal calendar, telecommunicated date, and the like), ambient light (e.g., by the ambient light sensor 244), and global position (e.g., the GPS unit 246, which could assist in indicating day/night cycles). One or more of these factors help to determine ambient light in the vehicle 220 thereby allowing the light 212 to be adjusted automatically. One or more of these readings can be implemented by one skilled in the art for adjusting the light 212 intensity provided by the backlight 215.

At step 360, a temperature of the liquid crystal panel 202 is controlled. In one example, temperature sensed by the temperature sensor 248 is communicated to the controller 204. As an adjunct to the control of the display contrast by the contrast voltage, the controller 204 controls the temperature control unit 210. In one example, the temperature control unit 210 has a heating element to provide heat to the liquid crystal panel 202. In one example, the temperature control unit 210 has a cooling element to provide cooling to the liquid crystal panel 202.

The method terminates at step 370 and is repeated at any step as required.

Those skilled in the art will recognize that step(s) may be eliminated, added, or modified in accordance with the present invention. Further, it will be appreciated that the display and method of controlling contrast of a liquid crystal display may vary from the examples provided herein. The present invention may be embodied in other specific forms without departing from the spirit or essential characteristics. The described examples are to be considered in all respects only as illustrative and not restrictive.

While the examples of the invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

What is claimed is:

1. A display comprising:
a liquid crystal panel;
a controller for controlling contrast voltage to the liquid crystal panel; and
a temperature sensor operably attached to the controller; wherein a display contrast of the liquid crystal panel is based on the contrast voltage; wherein the contrast voltage is based on a sensed temperature of the temperature sensor.

2. The display of claim 1 wherein the contrast voltage is inversely proportional to the sensed temperature.

3. The display of claim 1 wherein the liquid crystal display comprises a dialing keypad.

4. The display of claim 1 wherein the controller pulse width modulates the contrast voltage.

5. The display of claim 1 wherein the display is operably attached to a telematics unit.

6. The display of claim 5 wherein the telematics unit is selected from a group consisting of the temperature sensor, a time sensor, an ambient light sensor, and a global positioning system.

7. The display of claim 6 further comprising a display backlight operably attached to the telematics unit; wherein the display backlight operates based at least one of the time and date sensor, the ambient light sensor, and the GPS unit.

8. A method of controlling contrast of a liquid crystal display, the method comprising:
sensing a temperature; and
controlling contrast voltage to the liquid crystal display based on the sensed temperature.

9. The method of claim 8 wherein the contrast voltage is inversely proportional to the sensed temperature.

10. The method of claim 8 wherein the liquid crystal display comprises a dialing keypad.

11. The method of claim 8 further comprising pulse width modulating the contrast voltage.

12. The method of claim 8 further comprising backlighting the liquid crystal display.

13. The method of claim 12 wherein backlighting the liquid crystal display comprises sensing at least one of time, date, ambient light, and global position.

14. The method of claim 8 further comprising controlling temperature of the liquid crystal display.

15. A liquid crystal display comprising:
means for sensing a temperature; and
means for controlling contrast voltage to the liquid crystal display based on the sensed temperature.

16. The display of claim 15 further comprising means for pulse width modulating the contrast voltage.

17. The display of claim 15 further comprising means for backlighting the liquid crystal display.

18. The display of claim 15 further comprising means for controlling temperature of the liquid crystal display.
